(19) United States
(12) Patent Application Publication
(10) Pub. No.: US 2025/0214320 A1
(43) Pub. Date: Jul. 3, 2025

(54) LAMINATED GLAZED UNIT WITH AN OVERHANGING EXTERIOR GLASS SHEET, A WEDGE-SHAPED INTERLAYER AND A SEAL

(71) Applicant: SAINT-GOBAIN GLASS FRANCE, COURBEVOIE (FR)

(72) Inventors: Laurent SILVESTRINI, COURBEVOIE (FR); Cédric BODIN, THOUROTTE (FR)

(21) Appl. No.: 18/880,494

(22) PCT Filed: Jul. 26, 2023
(86) PCT No.: PCT/EP2023/070687

§ 371 Date: Dec. 31, 2024

(30) Foreign Application Priority Data
Jul. 28, 2022 (FR) 2207770

(51) Int. Cl. B32B 17/10; B32B 3/08; B32B 3/26

(52) U.S. Cl. CPC B32B 17/10036; B32B 3/08; B32B 3/263; B32B 17/10302; B32B 17/10568; B32B 2250/44; B32B 2307/536

(57) ABSTRACT

A glazed unit includes a glazed element laminated with an interlayer having a laterally non-constant thickness and an exterior glass sheet having an overhang forming a transverse offset oriented centrifugally with respect to the interior glass sheet, a base of a seal being attached to an inner face of the exterior glass sheet.

The invention relates to a laminated glazed unit comprising an interlayer of decreasing thickness along the length of the glazed unit, in particular for forming a motor vehicle windshield. Such a glazed unit reduces or even eliminates stray double images.

The state of the art is known from international patent application WO 2009/071135 A1, which discloses a curved windshield for a vehicle comprising an interlayer made of a thermoplastic and arranged between an exterior and an interior glass sheet. The thickness of the interlayer decreases longitudinally. The maximum thickness is at the top of the windshield, gradually decreasing to a minimum at the bottom. This specific dimensional configuration of the interlayer is known as the wedge shaped interlayer. A wedge shaped interlayer is used to reduce, or even eliminate, double images on a curved windshield. In fact, double images usually occur during night-time driving, from the headlight images of oncoming vehicles or other bright light sources. They are the result of multiple reflections on the windshield surfaces when part of the incident light beam, called the secondary beam, leaves the windshield at an angle to the primary beam. The angle between the primary and secondary beams is called the double image angle. Since the intensity of the secondary beam is very low, the secondary beam is only visible if it can be distinguished from the dark surroundings, for example when night has fallen.

This problem can be particularly troublesome for a glazed unit equipped with a so-called “Head Up Display.”

The thermoplastic generally used for the wedge shaped interlayer is polyvinyl butyral, better known by the acronym “PVB”. The curved windshield further comprises a polymer seal on its periphery. The seal is arranged on the top of the windshield and on the sides. The disadvantage of the current configuration of the glazed unit is that the lateral parts of the seal do not adapt to the reduction in thickness of the glazed unit from top to bottom. The result is an aesthetically unpleasant height difference which is visible to the naked eye. Noise can also be generated by unfavorable aerodynamic conditions. This noise is obviously unpleasant for the driver and passengers of the vehicle.

A laminated glazed unit configuration with an external overhang is also known in the prior art from European patent application No. EP 1025986. The exterior glass sheet protrudes beyond the interior glass sheet and comprises a profiled seal. The interlayer also has an overhang with respect to the interior glass sheet, but not with respect to the exterior glass sheet. A bead of adhesive bonds the exterior glass sheet, the interlayer and an intermediate element to an adjacent body rebate.

The aim of the invention is therefore to overcome the drawbacks of the prior art by proposing a glazed unit configuration that achieves reduced height differences, or even flushness, between the glass sheets, the seal and the vehicle opening.

The present invention is thus based on the discovery that, surprisingly, it is possible to provide a profiled seal with a base attached to the glazed element and a lateral bead (or lip) to equip the edges of a glazed element whose thickness is diminishing, and in particular when the profiled seal is a prefabricated seal (technology known as “pre-assembly” in the glass industry). One aim of the invention is thus to propose a glazed unit with a profiled seal that adapts well and easily to the decrease in thickness of the glazed element, for easier and less expensive installation.

To do so, the present invention thus relates, in its broadest sense, to a glazed unit for a vehicle, in particular for a motor vehicle, according to claim 1.

Said glazed unit comprises a laminated glazed element comprising an exterior glass sheet and an interior glass sheet, said glass sheets being assembled by means of an interlayer, said glazed unit having a first longitudinal edge, a second longitudinal edge, a first lateral edge and a second lateral edge, at least said lateral edges comprising a seal, said interlayer having a thickness that is not laterally constant, with a maximum thickness along said first longitudinal edge and a minimum thickness along said second longitudinal edge, said thickness decreasing progressively between said first longitudinal edge and said second longitudinal edge.

Said glazed unit is remarkable in that said exterior glass sheet has an overhang forming a transverse offset oriented centrifugally with respect to the interior glass sheet and the interlayer, the edge faces of the interior glass sheet and the interlayer being in line with one another, said seal having a base and a lateral bead, said base being attached to an inner face of said exterior glass sheet; said base preferably being attached only to said inner face of the exterior glass sheet (not attached to the other elements of the glazed element); said seal preferably being attached only to said inner face of the exterior glass sheet (not attached to an edge face of said exterior glass sheet, nor to an outer face of said exterior glass sheet; nor to the other elements of the glazed element).

Thus, since the edge faces of the interior glass sheet and the interlayer are in line with one another, while the edge face of the exterior glass sheet is further apart in the centrifugal direction (due to the overhang), only the interior glass sheet and the interlayer are affected by the reduction in interlayer thickness; neither the exterior glass sheet, nor the seal, nor the adhesive used to bond the glazed unit to the vehicle body is influenced (impacted) by the reduction in interlayer thickness.

Said base of the seal is thus attached to an inner face of the overhang of said exterior glass sheet.

The configuration proposed by the present invention makes it possible to reduce, or even eliminate, an external height difference between the seal of the glazed unit and the exterior glass sheet. The seal rests solely on the exterior glass sheet, eliminating the influence of variations in interlayer thickness.

Said second lateral edge may be parallel to said first lateral edge. Said second longitudinal edge may be parallel to said first longitudinal edge. Said lateral edges can be oriented substantially perpendicular to said longitudinal edges.

Preferably, said first longitudinal edge is an upper edge (intended to be arranged in an upper part of a vehicle opening) and said second longitudinal edge is a lower edge (intended to be arranged in a lower part of the vehicle opening).

Preferably, said profiled seal has a single base over its entire length and a single lateral bead over its entire length. Preferably, said base has a constant profile over its entire extent. Preferably, said bead has a constant profile over its entire extent.

Preferably, said overhang is present only along at least a portion of said first lateral edge and along at least a portion of said second lateral edge, and preferably along the entirety of said first lateral edge and along the entirety of said second lateral edge.

Preferably, said overhang is not present at all along said second, lower longitudinal edge; it may be present along said first, upper longitudinal edge or absent from said first, upper longitudinal edge.

Said base preferably extends from the rim located between the edge face of the exterior glass pane and the inner face of the exterior glass pane, to the edge face of the interlayer and the interior glass sheet, without necessarily being in contact with them. In order to provide a sufficiently large dimension, said base thus covers the inner face of the exterior glass sheet overhang.

Said bead extends, preferably, from said edge face of the exterior glass pane further than said edge face in the centrifugal direction.

Preferably, said base is attached to said inner face along the entirety of said first lateral edge and said second lateral edge. It may further be on said inner face along the entirety of said first longitudinal edge and/or along the entirety of said second longitudinal edge.

Preferably, said base is attached to said inner face by an adhesive tape, preferably of constant thickness.

Preferably, the exterior glass sheet has an inner face, the seal has an outer face, the adhesive tape has an outer face in contact with said inner face of the exterior glass sheet and an inner face in contact with said outer face of said seal.

Preferably, the adhesive tape is a double-sided acrylic adhesive or one with an acrylic-coated polyethylene backing.

Preferably, said seal has a constant profile over its entire extent.

Preferably, the overhang has a length of at least 4.0 mm and preferably between 2 and 4 times the thickness of the exterior glass sheet, or even between 2.5 and 3 times, in order to provide sufficient space to accommodate said base under said overhang.

Preferably, the seal comprises a first part and a second part when viewed in cross-section. Preferably, the first part has a higher Shore A hardness than the second part.

Preferably, the interior glass sheet has a centripetally oriented edge face and the seal has a centrifugally oriented edge face, the distance between the edge face of the interior glass sheet and the edge face of the seal being between 0.1 times and 2.0 times the maximum thickness of the interlayer.

The present invention also relates to a vehicle, in particular a motor vehicle, according to claim 10, comprising a body, a glazed unit and a bead of adhesive bonding said glazed unit to said body.

This glazed unit for this vehicle comprises a laminated glazed element comprising an exterior glass sheet having an edge face, an interior glass sheet having an edge face, said glass sheets being assembled by means of an interlayer having an edge face, said glazed unit having a first longitudinal edge, a second longitudinal edge, a first lateral edge and a second lateral edge, at least said lateral edges comprising a seal, said interlayer having a thickness that is not laterally constant, with a maximum thickness along said first longitudinal edge and a minimum thickness along said second longitudinal edge, said thickness decreasing progressively between said first longitudinal edge and said second longitudinal edge.

Said glazed unit of this vehicle is remarkable in that:
said exterior glass sheet has an overhang forming a transverse offset oriented centrifugally with respect to the interior glass sheet and the interlayer,
said seal has a base and a lateral bead, said base being attached to an inner face of said exterior glass sheet, said base preferably being attached only to said inner face of the exterior glass sheet, said seal preferably being attached only to said inner face of the exterior glass sheet, and
said adhesive bead is located between an inner face of the interior glass sheet and a rebate of said body located opposite an edge of said interior glass sheet.

Preferably, said bead of glue is free of contact with said interlayer; said bead of glue is preferably free of contact with said bead of the seal and even more preferably free of contact with said base of the seal.

The glazed unit of this vehicle can be a glazed unit according to the invention.

An embodiment of the present invention is described below by way of non-limiting example, with reference to the attached figures, wherein:

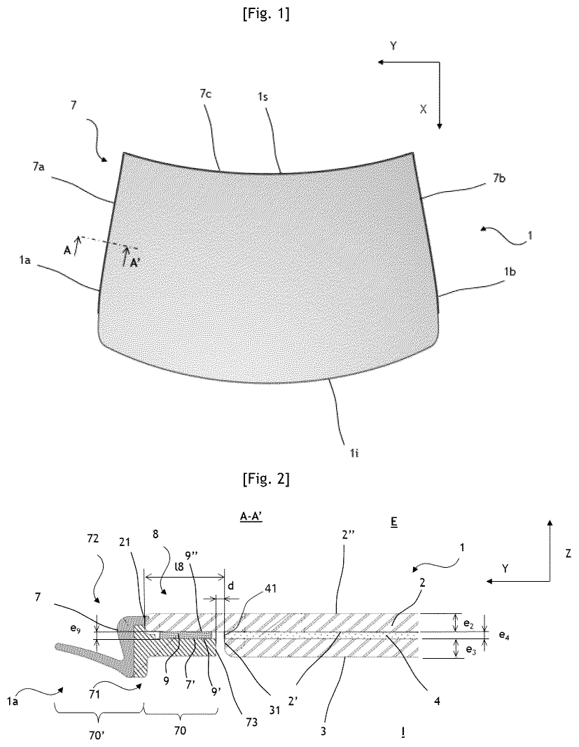

FIG. 1 shows a top view of a glazed unit, also known as a windshield, intended to be located in an opening at the front of a motor vehicle according to a preferred embodiment of the invention;

FIG. 2 schematically shows a detailed cross-sectional view, in a plane A-A′, of the glazed unit shown in FIG. 1; and

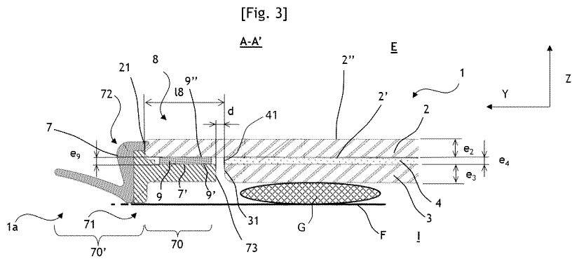

FIG. 3 schematically shows a detail and sectional view, similar to that of FIG. 2, showing the glazed unit bonded to a body rebate.

The present invention is described by way of example in the context of an application as glazed unit 1, fixed, for a vehicle. This glazed unit closes an opening by providing the separation between an exterior space E which is outside the vehicle, and an interior space I which is inside the vehicle. The concepts of “outer” and “inner” are therefore respectively considered in the present document with respect to this external space E (or oriented towards this external space) and this internal space I (or oriented towards this internal space).

FIG. 1 shows a top view of a motor vehicle glazed unit 1, here a windshield, according to a preferred embodiment of the present invention, intended for installation in an opening (not shown).

The glazed unit 1 can form a windshield, roof, side or rear window for a vehicle. The vehicle can be a road vehicle, such as a car, truck, bus, streetcar or rail vehicle. The glazing may be fixed (non-movable in the vehicle's frame of reference).

The glazed unit 1 includes a glazed element 2 that is curved (that is, not flat) and laminated.

The glazed unit 1 extends transversely along the axis generally called the “X axis” of the vehicle, in particular motor vehicle, which is the central longitudinal axis of the front of the motor vehicle equipped with the glazed unit according to the invention and which corresponds to the X axis in FIG. 1. The glazing unit 1 further extends along the axes Y and Z, which are respectively the transverse axis and the vertical axis of the motor vehicle.

In the context of the present document, the notions “centripetal” and “centrifugal” are considered, in the plane of the sheet in FIG. 1, to be expressed with respect to the center of the glazed unit, according to the X and Y axes; the centripetal direction is in the direction of this center whereas the centrifugal direction is away from this center.

In the embodiment(s) of the invention, a glazed unit 1 comprising a glazed element 10 is described. Each glazed element may be composite, that is, consists of several sheets of material, between which at least one layer of adhesive interlayer material is inserted, in the case of laminated glazing. The sheet(s) of material may be made of mineral material, in particular glass, having for example undergone annealing or tempering, or of organic material, particularly of plastic material such as polyvinyl butyral. The interlayer preferably contains at least one thermoplastic plastic material, preferably polyvinyl butyral (PVB), ethylene-vinyl acetate (EVA), and/or polyethylene terephthalate (PET). However, the thermoplastic interlayer may also contain, for example, polyurethane (PU), polypropylene (PP), polyacrylate, polyethylene (PE), polycarbonate (PC), polymethyl methacrylate, polyvinyl chloride, polyacetate resin, casting resins, acrylates, fluorinated ethylene propylene, polyvinyl fluoride and/or ethylene-tetrafluoroethylene, or copolymers or mixtures thereof. The thermoplastic interlayer may be formed from one or more superimposed thermoplastic films.

The glazed unit 1 has a first longitudinal edge 1s intended to be arranged in the upper part of the motor vehicle opening, that is, the part closest to the vehicle roof, and a second longitudinal edge 1i intended to be arranged in the lower part of the motor vehicle, that is, the part closest to the engine hood. The glazed unit 1 further has a first lateral edge 1a and a second lateral edge 1b on either side of the first and second longitudinal edges 1s, 1i.

The glazed unit 1 comprises a seal 7 having a central portion 7c arranged along the first longitudinal edge 1s of the glazed unit 1, a first lateral portion 7a arranged along the first lateral edge 1a and a second lateral portion 7b arranged along the second lateral edge 1b. The seal 7 is, for example, obtained by extrusion. The seal 7 is made of a polymer such as polyvinyl chloride, known by the acronym PVC, or ethylene propylene diene monomer, known by the acronym EPDM. The seal can also be made of a vulcanizable thermoplastic elastomer, also known by the acronym TPV. The seal 7 may be made of a single material or of two materials. The seal 7 can thus have a single hardness or two different hardnesses, due to the presence of two different materials. These materials preferably belong to the same family. The two-part seal 7 is produced by extrusion, for example.

The windshield shown in [FIG. 1] has no central portion along the second edge 1i. Such a glazed unit 1 may comprise, for example, a Head-Up Display (HUD). Information is projected to help the driver of the motor vehicle in his driving, for example the speed of the motor vehicle or certain information from the navigation system can be displayed. Information is usually projected at the bottom of the driver's field of vision. Double images can appear, particularly at night, from the headlight images of oncoming vehicles. The glazed unit 1 comprises an interlayer (not visible in [FIG. 1]) to attenuate or even eliminate double images.

Referring now to [FIG. 2], a cross-sectional view, along a sectional plane A-A′ visible in [FIG. 1], of the first lateral portion 1a of the glazed unit 1 is shown. The following description also applies to the second lateral portion 1b, mutatis mutandis. The glazed unit 1 comprises an exterior glass sheet 2 with a thickness e₂ and an interior glass sheet 3 with a thickness e₃. An interlayer 4, with a thickness e₄, is arranged between the exterior glass sheet 2 and the interior glass sheet 3. The thickness e₄ of the interlayer 4 is substantially constant in the width direction of the glazed unit 1, that is, along the orientation of the Y axis, and has a maximum thickness e₄, along the first longitudinal edge 1s and a minimum thickness e₄, along the second longitudinal edge 1i. Thus, when the glazed unit 1 is installed in the opening of the motor vehicle, the thickness of the interlayer 4 has a maximum thickness e₄, at the top of the glazed unit 1 and a minimum thickness e₄, at the bottom of the glazing 1. The thickness of the windshield 1 decreases in the same way. The exterior glass sheet 2 has a centrifugal transverse offset with respect to the interior glass sheet 3 and the interlayer 4 so as to comprise an overhang 8. The exterior glass sheet 2 has an inner face 2′ facing the inside I and an outer face 2″ facing the outside E. The first lateral portion 7a of the seal 7 has an outer face 7′ facing the inner face 2′ of the exterior glass sheet 2 at the overhang 8. The exterior glass sheet 2, the interlayer 4 and the interior glass sheet 3 have edge faces 21, 41 and 31, respectively, all oriented perpendicularly to the centripetal and centrifugal directions. The edge faces 31, 41 of the interior glass sheet 3 and the interlayer 4 are in line with one another.

The overhang 8 has a length l₈ between the edge face 21 of the exterior glass sheet 2 and both the edge face 31 of interior glass sheet 31 and the edge face 41 of the interlayer 4. Preferably, the length l₈ is at least 4.0 mm and is between 2 and 4 times the thickness e₂ of the exterior glass sheet 2.

The seal 7 is made up of two distinct parts: a base 70 and a lateral bead 70′. The base 70 is a part of the seal 7 which is attached to an inner face 2′ of the exterior glass 2, extending to the longitudinal or lateral edge of the exterior glass sheet 2. The bead 70′ is a part of the seal 7 that is not attached to the glazed element and extends from the base (that is, from the edge face 21 when installed in the glazed unit) further than the base 70 (that is, further than the edge face 21 when installed in the glazed unit) in the centrifugal direction. The profiled seal is attached to the glazed element 10 only by the fact that only the base 70 is attached to the inner face 2′ and only to this inner face 2′ (not to the interlayer 4 or to the interior glass sheet 3). In this way, the base 70 does not face the edge face 21; it is the bead that faces the edge face 21. The base 70 covers most, if not all, of the inner face of the overhang 8 of the exterior glass sheet 2.

When installed, the bead 70′ extends from the edge face 21, in this case in surface continuity with the outer face 2″ of the exterior glass sheet 2 (the bead 70′ is “flush” with the outer face 2″ of the exterior glass sheet).

The seal 7 and the exterior glass sheet 2 are joined by means of a double-sided adhesive tape 9 with an inner face 9′, an outer face 9″ and a thickness e₉. The inner face 9′ of the adhesive tape 9 is in contact with the outer face 7′ of the seal 7, and more specifically the outer face of the base 70. The outer face 9″ of the adhesive tape 9 is in contact with the inner face 2′ of the exterior glass sheet 2. In this way, the adhesive tape 9 is applied only to the exterior glass sheet 2, which has a substantially constant thickness e₂. This configuration thus produces a windshield 1 with controlled, constant deflection between the seal 7 and the exterior glass sheet 2.

Preferably, the exterior glass sheet 2 has a substantially constant thickness e₂ of between 1.6 mm and 2.1 mm. Preferably, the interior glass sheet 3 has a substantially constant thickness e₃ of between 1.6 mm and 2.1 mm. Preferably, the thicknesses e₂, e₃ of the exterior and interior glass sheets 2, 3 are substantially equal. Alternatively, the thicknesses e₂, e₃ of the exterior and interior glass sheets 2, 3 are different. Preferably, the interlayer 4 has a maximum thickness e_{4′}, along the first longitudinal edge 1s, of between 1.50 mm and 1.10 mm, or even between 1.30 mm and 1.20 mm. Preferably, interlayer 4 has a minimum thickness e_{4″}, along the second longitudinal edge 1i, of between 0.9 mm and 0.60 mm, or even between 0.80 mm and 0.70 mm. In a particular embodiment of the invention, the interlayer 4 has a maximum thickness e₄ equal to 1.26 mm and a minimum thickness e_{4″} equal to 0.76 mm.

In the embodiment shown in [FIG. 2], the seal 7 has a first part 71 with a Shore A hardness greater than the hardness of a second part 72. The seal 7 can for example be made of polyvinyl chloride (PVC) or ethylene propylene diene monomer (EPDM).

Here, the first part 71 has a Shore A hardness of 70 to 95 and the second part 72 has a Shore A hardness of 50 to 65. The fact that the second part has a lower hardness helps to limit the stress on the body; the fact that the first part has a higher hardness facilitates the stability of the bond on glass.

When the seal is made of a single material, its Shore A hardness is preferably between 50 and 95.

The adhesive tape 9 is a double-sided adhesive with an acrylic-coated polyethylene backing. The seal 7 has a centrifugally oriented edge face 73 facing the edge face 31 of the interior glass sheet 3. The distance d between the edge face 73 of the seal 7 and the edge face 31 of the interior glass sheet 3 is between 0.1 times and 2.0 times the maximum thickness e_{4′} of the interlayer 4, so as to be sufficiently compact.

Owing to the invention, along the entire length of the lateral edges 1a, 1b, the bead 70′ retains its profile and can extend from the edge face 21 in surface continuity with the outer face 2″ of the exterior glass sheet (the bead 70′ is “flush” with the outer face of the glazed element).

FIG. 3 shows a vehicle part according to the invention, in particular a motor vehicle part. This vehicle comprises a body, embodied here by a rebate F, a glazed unit 1 and a bead of adhesive G bonding said glazed unit to said body, and more precisely to the rebate F. The rebate F can in particular be a metal sheet which runs at least part of the way around the opening that the glazed unit 1 is meant to close, or even all the way around the opening that the glazed unit 1 is meant to close.

The glazed unit 1 is a fixed glazed unit: it is firmly bonded to the rebate F, and therefore to the body, by the adhesive bead G.

The glazed unit 1 comprises a laminated glazed element 10 comprising an exterior glass sheet 2 having an edge face 21, an interior glass sheet 3 having an edge face 31, said glass sheets 2, 3 being assembled by means of an interlayer 4 having an edge face 41, said glazed unit 1 having a first longitudinal edge 1s, a second longitudinal edge 1i, a first lateral edge 1a and a second lateral edge 1b, at least said lateral edges 1a, 1b comprising a seal 7, said interlayer 4 having a thickness e4 that is not laterally constant, with a maximum thickness e4′ along said first longitudinal edge 1s and a minimum thickness e4″ along said second longitudinal edge 1i, said thickness e4 decreasing progressively between said first longitudinal edge 1s and said second longitudinal edge 1i.

For this vehicle:
said exterior glass sheet 2 has an overhang 8 forming a transverse offset oriented centrifugally with respect to the interior glass sheet 3 and the interlayer 4,
said seal 7 has a base 70 and a lateral bead 70′, said base 70 being attached to an inner face 2′ of said exterior glass sheet 2, said base 70 preferably being attached only to said inner face 2′ of the exterior glass sheet 2, said seal preferably being attached only to said inner face 2′ of the exterior glass sheet 2, and
said adhesive bead G is located between an inner face 3′ of the interior glass sheet 3 and a rebate F of said body located opposite an edge of said interior glass sheet 3.

As shown, the adhesive bead G is preferably free of contact with said interlayer 4; said adhesive bead is preferably free of contact with said bead 71 of the seal 7 and even more preferably free of contact with said base 70 of the seal.

The bead 71 of the seal preferably rests on the rebate F. This support provides a constant reference; it is not influenced by the fact that the thickness of the interlayer 4 decreases progressively between the first longitudinal edge 1s and the second longitudinal edge 1i.

1. A glazed unit for a vehicle, comprising a laminated glazed element comprising an exterior glass sheet having an edge face, an interior glass sheet having an edge face, said exterior and interior glass sheets being assembled by an interlayer having an edge face, said glazed unit having a first longitudinal edge, a second longitudinal edge, a first lateral edge and a second lateral edge, at least said first and second lateral edges comprising a seal, said interlayer having a thickness that is not laterally constant, with a maximum thickness along said first longitudinal edge and a minimum thickness along said second longitudinal edge, said thickness decreasing progressively between said first longitudinal edge and said second longitudinal edge, wherein said exterior glass sheet has an overhang forming a transverse offset oriented centrifugally with respect to the interior glass sheet and the interlayer, the edge faces of the interior glass sheet and of the interlayer being in line with one another, said seal having a base and a lateral bead, said base being attached to an inner face of said exterior glass sheet.

2. The glazed unit according to claim 1, wherein said overhang is present only along at least a portion of said first lateral edge and along at least a portion of said second lateral edge.

3. The glazed unit according to claim 1, wherein said base is attached to said inner face along the entirety of said first lateral edge and said second lateral edge.

4. The glazed unit according to claim 1, wherein said base is attached to said inner face by an adhesive tape.

5. The glazed unit according to claim 4, wherein said adhesive tape is a double-sided acrylic adhesive or one with an acrylic-coated polyethylene backing.

6. The glazed unit according to claim 1, wherein said seal has a constant profile over its entire extent.

7. The glazed unit according to claim 1, wherein the overhang has a length of at least 4.0 mm.

8. The glazed unit according to claim 1, wherein said seal comprises, viewed in cross-section, a first part and a second part, the first part having a Shore A hardness greater than the hardness of the second part.

9. The glazed unit according to claim 1, wherein the interior glass sheet has a centripetally oriented edge face and the seal has a centrifugally oriented edge face, a distance between the edge face of the interior glass sheet and the edge face of the seal being between 0.1 times and 2.0 times a maximum thickness of the interlayer.

10. A vehicle, comprising a body, a glazed unit and a bead of adhesive bonding said glazed unit to said body, said glazed unit comprising a laminated glazed element comprising an exterior glass sheet having an edge face, an interior glass sheet having an edge face, said exterior and interior glass sheets being assembled by an interlayer having an edge face, said glazed unit having a first longitudinal edge, a second longitudinal edge, a first lateral edge and a second lateral edge, at least said first and second lateral edges comprising a seal, said interlayer having a thickness that is not laterally constant, with a maximum thickness along said first longitudinal edge and a minimum thickness along said second longitudinal edge, said thickness gradually decreasing between said first longitudinal edge and said second longitudinal edge,
wherein:
said exterior glass sheet has an overhang forming a transverse offset oriented centrifugally with respect to the interior glass sheet and the interlayer,
said seal has a base and a lateral bead, said base being attached to an inner face of said exterior glass sheet, and
said adhesive bead is located between an inner face of the interior glass sheet and a rebate of said body located opposite an edge of said interior glass sheet.

11. The vehicle according to claim 10, wherein said adhesive bead is without contact with said interlayer.

12. (canceled)

13. The glazed unit according to claim 1, wherein the vehicle is a motor vehicle.

14. The glazed unit according to claim 1, wherein said base is attached only to said inner face of the exterior glass sheet.

15. The glazed unit according to claim 1, wherein said seal is attached only to said inner face of the exterior glass sheet.

16. The glazed unit according to claim 2, wherein said overhang is present along the entirety of said first lateral edge and along the entirety of said second lateral edge.

17. The glazed unit according to claim 4, wherein said adhesive tape has a constant thickness.

18. The glazed unit according to claim 7, wherein the length of the overhang is between 2 and 4 times a thickness of the exterior glass sheet.

19. The glazed unit according to claim 18, wherein the length of the overhang is between 2.5 and 3 times the thickness of the exterior glass sheet.

20. The vehicle according to claim 12, wherein the vehicle is a motor vehicle.

21. The vehicle according to claim 12, wherein the base is attached only to said inner face of the exterior glass sheet.
